(19) United States
(12) Patent Application Publication
(10) Pub. No.: US 2026/0317151 A1
(43) Pub. Date: Oct. 15, 2026

(54) BEVERAGE DISPENSE SEQUENCING

(71) Applicant: Marmon Foodservice Technologies, Inc., Osseo, MN (US)

(72) Inventors: Ed Kryszkiewicz, Carol Stream, IL (US); James Bendig, Naperville, IL (US)

(73) Assignee: Marmon Foodservice Technologies, Inc., Osseo, MN (US)

(21) Appl. No.: 19/637,772

(22) Filed: Apr. 2, 2026

Related U.S. Application Data
(60) Provisional application No. 63/787,687, filed on Apr. 11, 2025.

(51) Int. Cl. B67D 1/08

(52) U.S. Cl. CPC B67D 1/0888; B67D 1/0894

(57) ABSTRACT

An automated beverage dispenser includes a cup dispenser and a carousel defining a plurality of carousel positions each with a cup holder. A controller is configured to receive a customer order having a plurality of beverage orders and allocate the beverage orders between at least first and second cup droppers prior to operation of the cup dispenser according to the first customer order.

### CROSS-REFERENCE TO RELATED APPLICATIONS

The present application claims priority of U.S. Provisional Patent Application No. 63/787,687, filed on Apr. 11, 2025, the contents of which is hereby incorporated by reference in its entirety.

### BACKGROUND

The present disclosure relates to beverage dispensing systems. More particularly, the present disclosure relates to sequencing the beverages dispensed by an automated beverage dispensing system.

Automated beverage dispensing systems are known in the fields of fast and quick service restaurants. Automated beverage dispensing systems automate, or partially automate the act of filling cups with beverages to fulfill customer orders.

Examples of automated beverage dispensing systems are disclosed in the following patent references, which are hereby each incorporated by reference herein in their entireties:
U.S. Pat. No. 3,279,652, “Cup Dispenser having a Plurality of Simultaneously Acting Circumposed Oscillating Cup Ejectors”; U.S. Pat. No. 4,418,837, “Automatic Cup Dispensing Apparatus”; U.S. Pat. No. 4,426,017, “Apparatus for Dispensing Containers from a Stack of Nested Containers”; and U.S. Pat. No. 5,518,149, “Cup Dispenser for Vending Machines” all disclose examples of cup dispensing devices.
U.S. Pat. No. 9,944,472, “Beverage Dispensing Apparatus” and U.S. Pat. No. 11,208,316, “Semi-Automated Beverage Dispensing Machines and Methods” disclose linear configurations for transport of cups for loading, filling, and/or staging by a beverage machine.
U.S. Pat. No. 10,689,240, “Automated Beverage Dispensing Machines” and U.S. Pat. No. 12,252,390, “Beverage Dispensing Machine with Cup Dispenser” disclose carousel-style configurations for transport of cups for loading, filling, and/or staging by a beverage machine.
U.S. Pat. No. 7,669,732, “Cup Lid Dispenser”; U.S. Pat. No. 8,225,960, “Ice Dispensing System and Method”; U.S. Pat. No. 9,204,734, “Cup Storage System”; U.S. Pat. No. 9,656,849, “Modular Valve array Having a Single Dispense Point”; U.S. Pat. No. 10,515,327, “Beverage Dispensing Validation Method and System”; U.S. Pat. No. 11,158,151, “Systems and Methods for Nesting Cups from a Dispenser”; and U.S. Patent Application Publication No. 2022/0106181, “Beverage Dispensing Apparatus” all disclose other features which may be incorporated into examples of a beverage dispensing machine as disclosed in further detail herein.

### BRIEF DISCLOSURE

According to an aspect of the present disclosure, an automated beverage dispenser is provided. The automated beverage dispenser includes a cup dispenser having at least a first cup dropper and a second cup dropper. The automated beverage dispenser includes a carousel defining a plurality of carousel positions each with a cup holder. The carousel is configured to move the carousel positions about the carousel through a plurality of locations. The plurality of locations includes a first loading location coincident to the first cup dropper and a second loading location coincident to the second cup dropper. The automated beverage dispenser includes a beverage dispensing system configured to dispense a beverage. The plurality of locations of the carousel includes a beverage dispense location coincident to the beverage dispensing system. The automated beverage dispenser includes a controller configured to receive a first customer order having first one or more beverage orders and allocate the one or more beverage orders between at least the first cup dropper and the second cup dropper.

According to other aspects of the present disclosure, the automated beverage dispenser may include one or more of the following features. The first cup dropper and the second cup dropper may be respectively configured to receive a stack of cups, singulate a cup from the stack, and to deliver the singulated cup to a cup holder of the carousel. The controller may be configured to operate the first cup dropper to dispense a first cup into the cup holder at the first loading location. The controller may be further configured to assign the beverage order allocated to the first cup dropper to a first carousel position of the plurality of carousel positions that is currently at the first loading location.

According to other aspects of the present disclosure, the controller may be configured to operate the second cup dropper to dispense a second cup into the cup holder at the second loading location. The controller may be further configured to assign the beverage order allocated to the second cup dropper to a second carousel position of the plurality of carousel positions that is currently at the second loading location. The carousel may be configured to advance the first carousel position to the beverage dispense location of the plurality of locations of the carousel. The controller may be configured to operate the beverage dispense system to dispense the beverage according to the beverage order assigned to the first carousel position. The controller may be configured to confirm that the first carousel position has not been assigned a beverage order before operating the first cup dropper to dispense the first cup into the cup holder at the first loading location. The controller may be configured to cause the carousel to advance so that the first carousel position is located at the second loading location and then evaluate if the first cup dropper has at least one beverage order allocation.

According to other aspects of the present disclosure, the controller may be configured to assign the beverage order to a carousel position after a cup of the beverage order has been dispensed to that carousel position. The beverage order includes instructions for the beverage to be dispensed from the beverage dispensing system when the carousel position reaches the beverage dispense location. The controller may be configured to evaluate the beverage orders allocated to at least the first cup dropper and the second cup dropper and then to evaluate unassigned carousel positions before loading a subsequent customer order having one or more subsequent beverage orders. The cup dispenser may further include a third cup dropper and a fourth cup dropper. The plurality of locations may further include a third loading location coincident to the third cup dropper and a fourth loading location coincident to the fourth cup dropper. Each of the first, second, third, and fourth cup droppers may occupy a separate fixed location relative to the carousel.

According to another aspect of the present disclosure, a method of automated beverage dispensing is provided. The method includes receiving a customer order having at least a first beverage order and a second beverage order. The method includes allocating the first beverage order to a first cup dropper of a cup dispenser and allocating the second beverage order to a second cup dropper of the cup dispenser. The first cup dropper is at a first fixed location that coincides with a first loading location of a plurality of carousel locations. The second cup dropper is at a second fixed location that coincides with a second loading location of the plurality of carousel locations. The method includes operating at least one of the first cup dropper and the second cup dropper to dispense a cup into a cup holder of the carousel at the respective first loading location or second loading location. The method includes decrementing the first beverage order and/or the second beverage order from the allocation to the at least one of the operated first cup dropper and second cup dropper. The method includes assigning the first beverage order and/or the second beverage order to the carousel position of the plurality of carousel positions to which the respective first cup dropper and/or second cup dropper dispensed a cup.

According to other aspects of the present disclosure, the method may further include advancing the carousel position to a beverage dispense location and operating a beverage dispense system that coincides with the beverage dispense location to dispense the beverage according to the first beverage order or the second beverage order assigned to the carousel position. The method may further include evaluating the plurality of carousel positions, each carousel position of the plurality of carousel positions having a cup holder, to determine if the carousel position has already been assigned a beverage order.

According to other aspects of the present disclosure, at each of the first cup dropper and the second cup dropper the method may include determining if the cup holder at the currently coinciding carousel position is empty by evaluating a sensor signal. The method may include evaluating if a beverage order has been assigned to the currently coinciding carousel position. The method may include evaluating if the cup dropper has at least one beverage order allocation. The method may include subsequently dispensing a cup when the cup holder at the currently coinciding carousel position is empty, no beverage order is currently assigned to the currently coinciding carousel position, and the cup dropper has at least one beverage order allocation.

According to other aspects of the present disclosure, the method may further include receiving a plurality of customer orders, each customer order having at least one beverage order. The method may include allocating the at least one beverage order of a next customer order of the plurality of customer orders if both a total number of beverage orders allocated to the first and second cup droppers is less than a total number of cup droppers and a total number of allocated beverage orders is less than a total number of currently unassigned conveyor positions. The method may include advancing the carousel to a next position increment if either of the total number of beverage orders allocated to the first and second cup droppers is greater than or equal a total number of cup droppers or a total number of allocated beverage orders is greater than or equal to a total number of currently unassigned conveyor positions.

According to other aspects of the present disclosure, the method may further include a third cup dropper at a third fixed location that coincides with a third loading location of a plurality of carousel locations. The method may include allocating a third beverage order to the third cup dropper. The method may include confirming that no beverage orders have been assigned to first, second, or third carousel positions, each associated with respective cup holder of the carousel at the respective first, second, and third loading locations. The method may include operating the first, second, and third cup droppers to simultaneously dispense cups into the cup holders of the first, second and third carousel positions. The method may include assigning the first beverage order to the first carousel position, assigning the second beverage order to the second carousel position, and assigning the third beverage order to the third carousel position. The method may include advancing the first carousel position to a beverage dispense location and operating a beverage dispense system that coincides with the beverage dispense location to dispense the beverage according to the first beverage order.

According to another aspect of the present disclosure, a method of automated beverage dispensing from an automated beverage dispenser is provided. The automated beverage dispenser includes a first cup dropper, a second cup dropper, and a carousel defining a plurality of carousel positions each with a cup holder. The carousel is configured to move the carousel positions about the carousel through a plurality of locations. The plurality of locations includes a first loading location coincident to the first cup dropper and a second loading location coincident to the second cup dropper. The method includes receiving a customer order having at least a first beverage order and a second beverage order. The method includes allocating the first beverage order to the first cup dropper and allocating the second beverage order to the second cup dropper. The method includes evaluating the plurality of carousel positions to determine if a first carousel position at the first loading location or a second carousel position at the second loading location are assigned with a beverage order. The method includes operating the first cup dropper and/or the second cup dropper to dispense a cup into a cup holder at the first carousel position and/or the second carousel position not assigned with a beverage order. For either of the first cup dropper or the second cup dropper, if a cup was dispensed, the method includes decrementing the allocation of the respective first beverage order and/or the second beverage order and assigning the first beverage order and/or the second beverage order to the respective first carousel position and/or the second carousel position. The method includes advancing the carousel to position the first carousel position or the second carousel position at a beverage dispense location of the plurality of locations. The method includes operating a beverage dispense system that coincides with the beverage dispense location to dispense the beverage according the beverage order assigned to the first carousel position or the second carousel position.

According to other aspects of the present disclosure, at each of the first cup dropper and the second cup dropper the method may include determining if the cup holder at the currently coinciding carousel position is empty by evaluating a sensor signal. The method may include evaluating if a beverage order has been assigned to the currently coinciding carousel position. The method may include evaluating if the cup dropper has at least one beverage order allocation. The method may include subsequently dispensing a cup when the cup holder at the currently coinciding carousel position is empty, no beverage order is currently assigned to the currently coinciding carousel position, and the cup dropper has at least one beverage order allocation.

According to other aspects of the present disclosure, the method may further include receiving a plurality of customer orders, each customer order having at least one beverage order. The method may include allocating the at least one beverage order of a next customer order of the plurality of customer orders if both a total number of beverage orders allocated to the first and second cup droppers is less than a total number of cup droppers and a total number of allocated beverage orders is less than a total number of currently unassigned conveyor positions. The method may include advancing the carousel to a next position increment if either of the total number of beverage orders allocated to the first and second cup droppers is greater than or equal a total number of cup droppers or a total number of allocated beverage orders is greater than or equal to a total number of currently unassigned conveyor positions.

### BRIEF DESCRIPTION OF THE DRAWINGS

FIG. 1 is a perspective view of an example of a beverage dispensing machine.

FIG. 2 is a front view of the beverage dispensing machine.

FIG. 3 is a sectional view taken along line 3-3 of FIG. 2.

FIG. 4 is a flow chart of a method of sequencing beverages.

FIG. 5 is a flow chart of the method of sequencing beverages at a cup dispenser.

FIG. 6 is a flow chart of a method of loading customer orders.

FIGS. 7A-7E are diagrammatic depictions of the relative operations during an example of beverage sequencing.

FIG. 8 is a system diagram of the beverage dispensing machine.

### DETAILED DISCLOSURE

Automated beverage dispensing machines, for example as disclosed in U.S. Pat. No. 12,252,390, “Beverage Dispensing Machine with Cup Dispenser” combine the automated dispensing of cups with the automated filling of those cups with a beverage to complete customer orders for specified beverage types and volumes.

Automated beverage dispensing machines have typically operated to dispense cups to a single location. This is exemplarily shown in U.S. Pat. No. 9,944,472, “Beverage Dispensing Apparatus” or U.S. Pat. No. 10,689,240, “Automated Beverage Dispensing Machines.” Because the cups are delivered to a single point, the beverage dispensing machine can operate in a first-in-first-out (FIFO) manner to process received beverage orders. As each beverage in a customer order comes up, the machine operates to dispense the specified cup and then fill that cup with the specified beverage. However, more recent beverage dispensing machines are configured to dispense different cups to different locations, this is exemplarily disclosed in U.S. Pat. No. 12,252,390. This opens the possibility to dispense multiple cups at the same time, however, this arrangement also only dispenses a single cup size at any one given location. Therefore, improved arrangements of sequencing cup dispense and filling to fulfill customer orders are needed and disclosed herein.

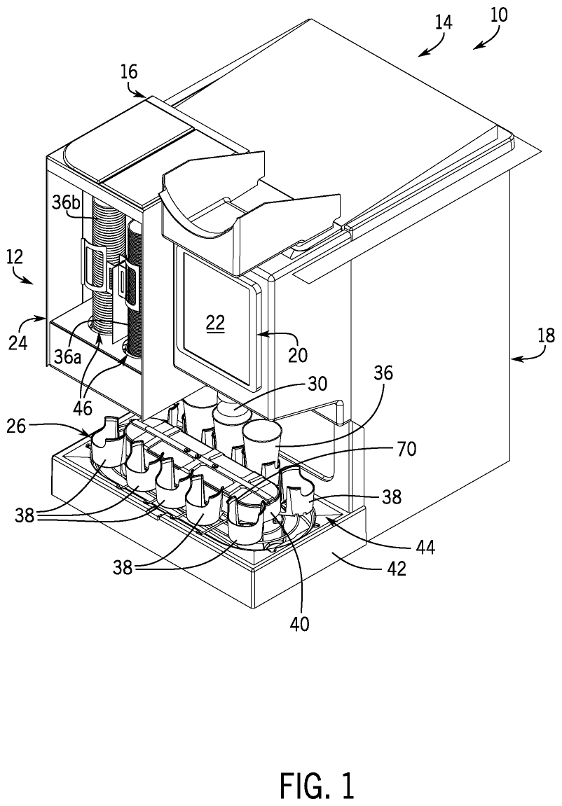

FIG. 1 is a perspective view of an example of a beverage dispensing machine 10 which is configured as a “crew serve” dispensing machine to automatedly or semi-automatedly dispense beverages consistent with a customer's order. The beverage dispensing machine 10 is configured to provide automated cup selection, placement, ice dispensing, beverage dispensing, and staging of customer-ordered beverages in a fast or quick service restaurant setting. Automation of crew-served beverage fulfillment process as provided with the features of the disclosure herein can improve the speed of service and order completion accuracy.

The beverage dispensing machine 10 is defined by a front 12, a back 14, and sides 16, 18. The beverage dispensing machine 10 is both observable and configurable from the front to facilitate operation in a restaurant setting. That is, the user interface 22, which may include a graphical display 20, the cup dispenser 24, and the cup carousel 26 are positioned at the front 12 of the beverage dispensing machine 10. As will be described in further detail herein, the beverage dispensing machine further includes an ice dispensing chute 30 and a beverage dispensing nozzle 34.

The cup carousel 26 includes a plurality of cup holders 38 which are configured to receive a cup 36 therein. The cup holders 38 thus define the positions of any cups relative to the cup carousel 26. The cup carousel 26 may further include a conveyor belt 40 to which the cup holders 38 are secured. A shelf 42, for example with a drip tray 44 defined therein, underlies the cup holders 38 and the cup carousel 26. The shelf 42 and drip tray 44 serve to catch spilled beverage, ice, or debris so as not to interfere with the operation of the cup carousel 26 and the beverage dispensing machine 10. Operation of a motor (not depicted), exemplarily a servo motor, rotates the conveyor belt 40, along with the cup holders 38 secured thereto about an exterior of the cup carousel 26. The motor rotates the conveyor belt 40 to position the plurality of cup holders 38 at a plurality of successive indexed locations about the cup carousel 26.

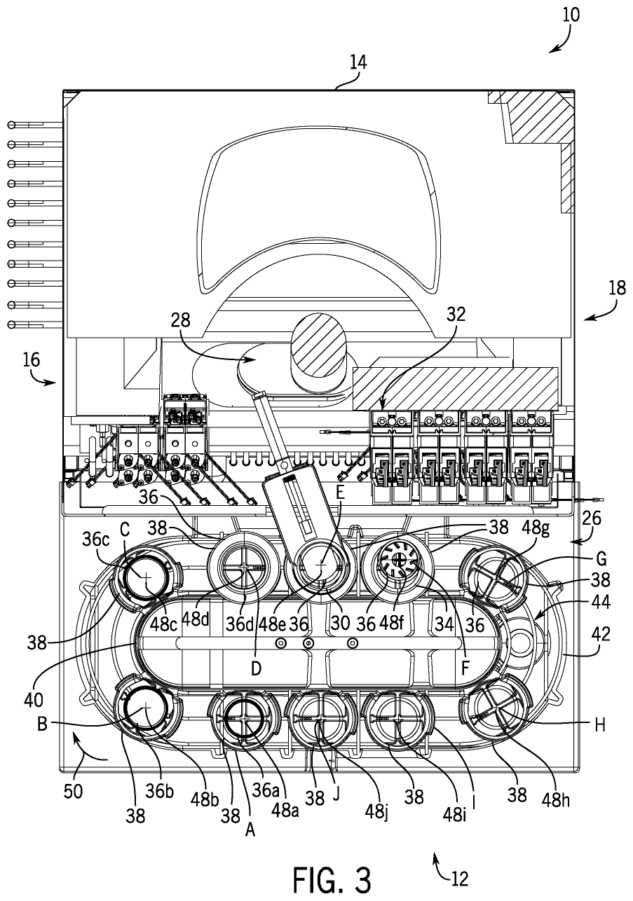

As will be explained in further detail herein, the carousel 26 has cup holders 38 at each of a plurality of carousel positions. The carousel 26 moves the cups holders 38 at these associated carousel positions through a plurality of indexed locations, each of which coincide with a function of the beverage dispensing machine. While provided in more detail with respect to FIG. 3, these indexed locations are exemplarily represented as locations 48a-48j. In brief description, indexed locations 48a-48d coincide with the cup dispenser 24, indexed location 48e coincides with the ice dispensing chute 30, indexed location 48f coincides with the nozzle 34, and indexed locations 48g-48j are staging locations for cups 36 filled with a dispensed beverage.

The cup dispenser is arranged to dispense cups of one or more different sizes to different indexed locations within the automated beverage dispenser. The automated beverage dispenser may include a carousel that defines a plurality carousel positions which are moved to align with the series of indexed locations about the carousel path and each associated with a function of the beverage dispenser. The cup dispenser dispenses cups of different sizes into the coincident indexed locations. The automated beverage dispenser may further operate to maintain a record of cups dispensed into cup holders 38 at particular positions about the carousel.

The cup dispenser 24 is configured to hold a plurality of stacks of cups 36 in which the beverages are to be dispensed. Each stack of cups is supported by and selectively released from an associated cup dropper 46. In the example shown, the cup dispenser 24 includes four stacks 36a-36d of cups, each of which has an associated cup dropper 46. It will be recognized that more or fewer stacks of cups may be provided while remaining within the scope of the present disclosure. Each of the stacks 36a-36d of cups may exemplarily be a different size, configured to hold a different volume of beverage. In other examples, the two or more of cup droppers 46 may be dimensioned and/or configured to hold and dispense cups of the same size, holding the same volume of beverage. The stacks 36a-36d of cups may be arranged with one or more stacks positioned behind, or towards the back 14 of the beverage dispensing machine 10 from other stacks. Alternatively, the stacks 36a-36d may be arranged with one or more stacks positioned towards the front 12 of the beverage dispensing machine or towards the side 16, 18 of the beverage dispensing machine. That is, each of the stacks 36a-36d occupies a separate fixed location relative to the rest of the beverage dispensing machine. The cup dispenser is arranged with cup droppers 46 to dispense cups from each of the stacks 36a-36d to different indexed locations 48a-48d about the carousel 26 within the automated beverage dispenser. The cup droppers 46 are arranged to singulate a cup from the associated stack 36 of cups and to deliver the singulated cup to the cup holder 38 at the location coincident with the cup dropper, exemplarily in part by gravity. Non-limiting examples of cup droppers are disclosed in U.S. Pat. Nos. 11,440,785 and 12,252,390 which are incorporated by reference herein in their entireties.

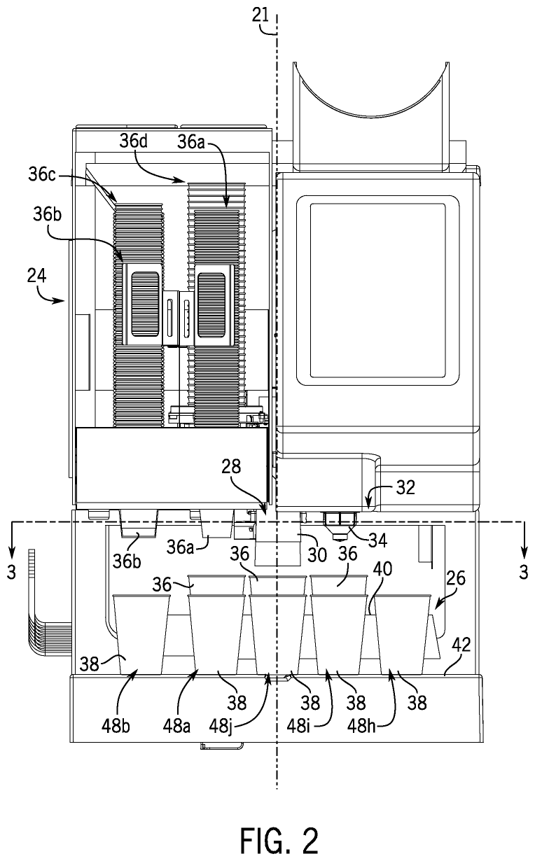

FIG. 2 is a front view of the beverage dispensing machine 10. Representative cup holders 38 at indexed locations 48a, 48b, and 48h-48j are visible from the front, with indexed locations 48c-48g set behind and visible in other views. FIG. 2 further depicts the ice dispensing chute 30, to which an ice dispenser 28 is connected for the dispense of ice into a cup 36 located at indexed location 48e. While not specifically depicted, the ice dispenser 28 exemplarily includes an ice bin associated with a cold plate, and may further include an auger or agitator which is operated to dispense a portion of the ice from the ice bin out through the ice dispensing chute 30. Further details of examples of these components may be found in US Patent Application Publication No. 2025/0243047, “Carbonator and Cold-Plate System” which is incorporated by reference herein in its entirety. Nozzle 34 is further connected to a beverage dispensing system 32 for the dispense of an ordered beverage into a cup 36 located at indexed location 48f. While not specifically depicted, the beverage dispensing system further includes a plurality of fluid control valves which are operated to control the flow of pre-mixed beverages or beverage constituents. Fluid control valves may be operated to selectively dispense concentrated flavoring and a diluent fluid (e.g. still or carbonated water) from the nozzle 34 according to a drink order from a customer.

In the example depicted in FIG. 2, stack 36a, which exemplarily includes small (e.g. 12 oz) sized cups, is positioned towards the front of the beverage dispensing machine and medially, e.g. towards the midline 21 of beverage dispensing machine 10 relative to another stack in the cup dispenser 24. The stack 36b, which exemplarily includes medium (e.g. 16 oz) sized cups, is positioned towards the front of the beverage dispensing machine 10 and laterally, e.g. away from the midline 21 of the beverage dispensing machine 10, relative to another stack in the cup dispenser 24. The stack 36c, which exemplarily includes large (e.g. 21 oz) sized cups, is positioned behind stack 36b, and also laterally away from the midline 21 relative to another stack in the cup dispenser 24. The stack 36 d, which exemplarily includes extra-large (e.g. 32 oz) sized cups, is positioned behind stack 36a and also medially towards the midline 21 relative to another stack in the cup dispenser 24. As seen in FIG. 3, stack 36b is further positioned towards the back 14 of the beverage dispensing machine from the stack 36a and the stack 36c is positioned towards the front 12 from stack 36d and towards the back 14 from stack 36b. It will be recognized that these positions and examples are merely exemplary and non-limiting as to the order, position, and location of the respective cups and sizes of cups and associated cup dispensing assemblies, within the scope of the present disclosure.

FIG. 3 further depicts the cup carousel 26 and is a sectional view of the beverage dispensing machine 10 taken along line 3-3 of FIG. 2. The cup carousel 26 exemplarily includes ten cup holders 38. Each of the cup holders 38 is represents a carousel position A-J. As previously noted, the cup carousel 26 operates to move the cup holders 38 and the carousel position of these cup holders 38 through a sequence of indexed locations 48a-48j. The plurality of indexed locations 48a-48j around the carousel 26 thus defines an endless circuit of sequential indexed locations 48a-48j through which the cup holders 38 and associated carousel positions A-J are moved with the cup holder 38 at indexed location 48j advancing to indexed location 48a. The cup holders 38 may be secured to the conveyor belt 40 with a dovetail connection, while other types of releasable connections may also be used. The beverage dispensing machine 10 is for example calibrated such that the carousel position of each of the cup holders is known, for example by initially locating the cup holders at carousel positions A-J respectively at indexed locations 48a-48j. The conveyor belt 40 may be a silicone or rubber belt or may be formed of a plurality of articulated sections. In examples, flexibility or articulation in the conveyor belt 40 may provide a degree of lateral flexibility which facilitates conformity of the conveyor belt about the gears at either end of the cup carousel 26.

Indexed locations 48a-48d respectively coincide with the stacks 36a-36d of cups and the associated cup droppers 46 and therefore represent a plurality of cup loading locations. That is, a cup 36 dispensed from stack 36a of cups by the associated cup dropper 46 will drop into cup holder 38 positioned at indexed location 48a. A cup 36 dispensed from stack 36b of cups by the associated cup dropper 46 will drop into cup holder 38 positioned at indexed location 48b. A cup 36 dispensed from stack 36c of cups by the associated cup dropper 46 will drop into cup holder 38 positioned at indexed location 48c. A cup 36 dispensed from stack 26d of cups by the associated cup dropper 46 will drop into cup holder 38 positioned at indexed location 48d. Indexed location 48e coincides with the ice dispensing chute 30 of the ice dispenser 28. Ice dispensed through the ice dispensing chute 30 will fall into a cup positioned at indexed location 48e. Indexed location 48f coincides with the nozzle 34 of the beverage dispenser. A beverage dispensed through the nozzle 34 will fall into a cup positioned at indexed location 48f. Indexed locations 48g-48j respectively represent a plurality of staging locations of the plurality of indexed locations.

As noted above, because the cup dispenser 24 operates to dispense cups to cup holders at multiple indexed locations, improved systems and methods for the sequencing of beverage orders are needed to optimally drop cups 36 into available cup holders 38 and assign beverage orders to individual carousel positions for proper filling with ice and/or beverage to complete a customer order.

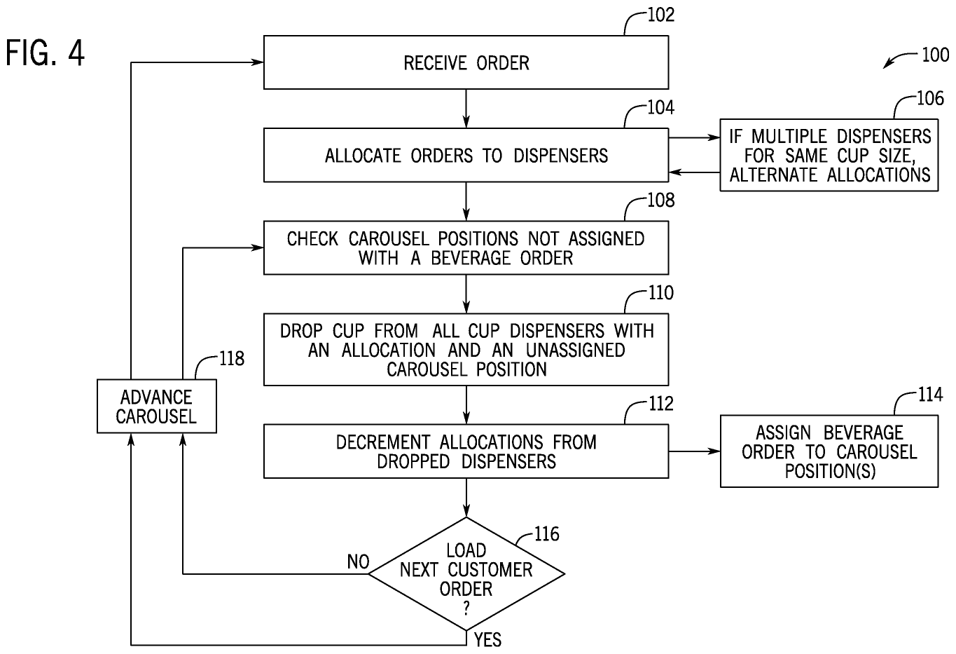

FIG. 4 is a flow chart of an example of a method 100 of dispensing cups within an automated beverage dispensing machine 10. It will be recognized that while the example configuration of an automated beverage dispensing machine 10 above is described, that the method 100 may be performed using other configurations of automated beverage dispensing machines, at least some of the method 100 described herein may be performed by a controller executing computer readable code.

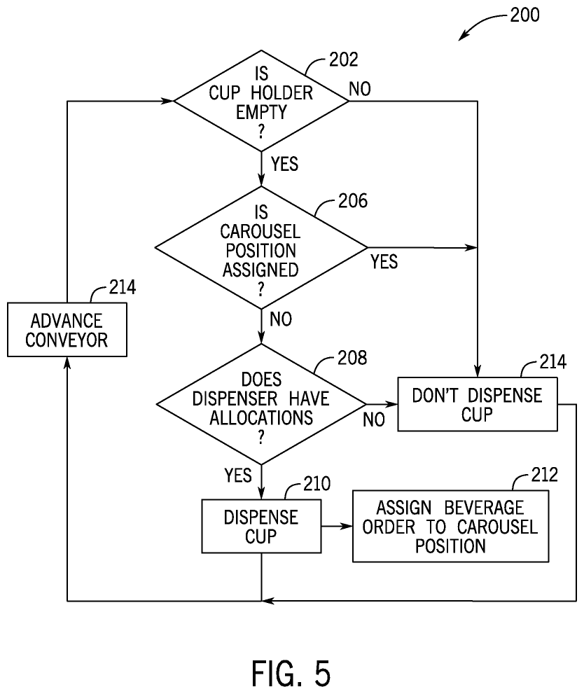

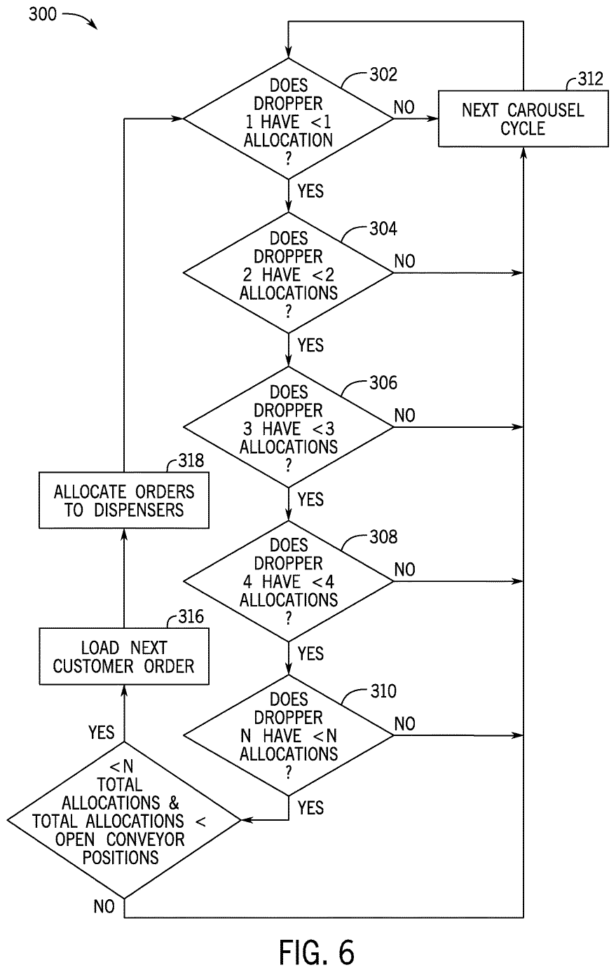

As described herein in relation to FIG. 4, but also in combination with FIGS. 5 and 6, the controller may evaluate multiple conditions before loading a subsequent customer order. In some aspects, the controller determines the status of which carousel positions have been assigned beverage orders, the controller determines the amount and status of order allocations to the cup droppers, the controller confirms if a cup holder of a carousel position is empty or filled with a cup based upon a cup sensor signal and compares this determination to an expected status of the cup holder. The controller may determine whether the total number of beverage orders currently allocated to all cup droppers is less than the total number of cup droppers in the system. In some aspects, the controller also determines whether the total number of allocated beverage orders is less than the total number of currently unassigned carousel positions. When both conditions are satisfied, the controller may load the next customer order and allocate its beverage orders to the cup droppers. When either condition is not satisfied, the controller advances the carousel to the next position increment before re-evaluating the conditions. This threshold-based approach ensures that the system does not become overloaded with pending orders and that carousel positions remain available for new cups.

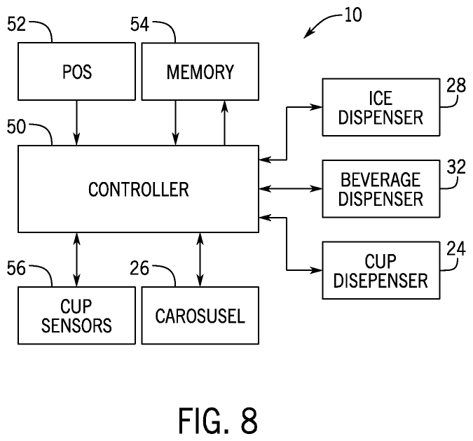

The method 100 begins at 102 with receiving a customer order which includes one or more beverage orders. It will be recognized herein that a customer order is a grouping of one or more beverages and/or food items intended to be delivered to an individual as a set. Typically, a customer order is associated with a single payment entry at the point of sale (POS) (52 FIG. 8). In implementation, the POS may take numerous forms, including but not limited to a manual entry at a terminal by a foodservice worker taking the order, or customer-entered through a user interface presented at restaurant ordering kiosk, an application presented on a personal smartphone, or entered through a web browser. Still further POS implementations may include receipt of the customer order from a software agent (e.g., an AI-based agent) that communicates the customer order to the POS on behalf of the customer. Since a customer order is generally assumed to be delivered to specific customer, it is desirable to group beverages of a single customer order together. Different examples of customer orders will be used herein, but for the purposes of describing the method 100, the customer order can be understood to include multiple beverage orders, and for the purposes of an example, multiple beverage orders of a first cup size (e.g. large) and at least one additional beverage order of a second cup size (e.g. medium). These orders are provided from the POS to the automated beverage dispenser where a controller (50 FIG. 8) operates to carry out some or all of the method herein. It will be recognized that the communication of the orders to the automated beverage dispenser may be done directly from the POS, or through one or more intermediary software levels, for example, an order broadcaster operating on a networked computer that routes components of orders (e.g. foods, beverages, pre-packaged items) among kitchen devices, including but not limited to automated beverage dispenser(s).

As used herein, the term “allocation” refers to the association of a beverage order with a particular cup dropper prior to the dispensing of a cup for that beverage order. The allocation indicates which cup dropper will be used to dispense a cup for the beverage order. In contrast, the term “assignment” refers to the association of a beverage order with a particular carousel position after a cup has been dispensed into the cup holder at that carousel position. The assignment indicates which carousel position contains the cup for the beverage order and includes instructions for the beverage to be dispensed when the carousel position reaches the beverage dispense location. The instructions may also include for a type or amount of ice to be dispensed when the carousel position reaches the ice dispense location. The controller maintains allocations and assignments as separate records, with allocations being decremented when a cup is dispensed and assignments being created when a cup is dispensed into a carousel position.

At 104 the beverage orders (e.g. two large cups and one medium cup) are allocated to a queue of the respective cup droppers. That is, large cup beverage orders are allocated to the queue of the dropper of large cups and the medium cup beverage order is allocated to the queue of the dropper of medium cups. Additional details of an example method of beverage order allocation will be described further with respect to the method 200 of FIG. 5. As an optional feature, at 106, if multiple cup droppers are configured to dispense the same (e.g. high frequency) cup size (e.g. two cup droppers dispensing large size cups), then the allocation of cup orders between those two droppers is split in an alternating fashion. In the example used herein one large cup would be allocated to each of the droppers of large cups. In such an instance, this distributes the wear and time to replenishment of the supplies of cups in those droppers.

At 108, the controller checks which carousel positions already have cups assigned thereto. It will be recognized that upon initial start, or if there is a time gap in between customer orders (e.g. a time of low order volume or intermittent orders) that carousel positions currently in the cup loading indexed locations (e.g. 48a-48d) will not have cups assigned. However, if there is a large queue of customer orders and many beverages to dispense, then frequently, only the carousel position rotating to indexed location 48a from the last staging indexed location 48j will be unassigned, as described in further detail herein.

With this information regarding the status of each of the carousel positions currently at the cup dispensing indexed locations, at 110 any cup dispenser with a beverage order allocated to the queue for that beverage dispenser and an unassigned carousel position located at the indexed location for that cup dispenser is operated to drop a cup. Therefore, in examples, all four cup dispensers may operate to dispense cups if all four dispensers have allocations and all four associated carousel positions are unassigned. On the other hand, if all of the available carousel positions were filled with cups after a previous advance of the carousel, then in the current carousel positioning, only the carousel position at indexed location 48a would be unassigned and therefore available to receive a cup from the cup dropper 46 coincident with indexed location 48a, if there are any beverage orders allocated to that cup dropper 46.

In a non-limiting example of beverage dispense sequencing efficiency, the controller operates multiple cup droppers simultaneously during a single carousel cycle. For example, when a customer order includes four beverages, the controller may potentially allocate one beverage order to each of the first, second, third, and fourth cup droppers. The controller then confirms that no beverage orders have been assigned to the carousel positions currently at the first, second, third, and fourth loading locations. Upon confirmation, the controller simultaneously operates all four cup droppers to dispense cups into the respective cup holders. The controller then assigns the respective beverage orders to each carousel position that received a cup. This simultaneous operation reduces the number of carousel cycles required to fulfill a multi-beverage order, thereby improving throughput and reducing customer wait times. This, for example, may occur when there has been a temporal gap between customer orders and therefore, no other customer orders needed to be dispensed and fulfilled before operating according to the current customer order.

At 112 the beverage order allocations at each of the dispensers that dropped cups are decremented to reflect this action. At the same time, at 114, the controller operates to assign the beverage order associated with the dropped cup(s) to the respective carousel position(s). This assignment of the beverage order combines the cup size at the carousel position with the ice and beverage to be dispensed into that cup. This information is used as described in further detail herein respectively by the ice dispenser 28 and the beverage dispenser 32 to complete the beverage order when the associated carousel position advances to the ice dispensing location 48e and the beverage dispensing location 48f.

Next, at 116, the controller determines if a next customer order should be loaded from the POS and allocated among the cup dispensers. This process will be explained in further detail with respect to the method 300 of FIG. 6. Whether or not one or more next orders are loaded, the automated beverage dispenser 10 operates to advance the carousel, exemplarily moving each carousel position forward one indexed location. If a next customer order was loaded, the method returns to 102 for allocation of that order. If a next customer order was not loaded, then the method may return to 108 to determine the next operation of cup dispenses.

In still further examples, a user input, for example into the graphical display 20, may initiate a cut-in or priority beverage order. Upon a user input of such a beverage order, this beverage order is loaded and allocated upon receipt and subsequently assigned to the next unassigned carousel position. This cut-in exemplarily may be within a customer order, or in another example, may take place between customer orders.

FIG. 5 is a flow chart of an example of a more detailed method 200 of the operation of each cup dropper referenced above in the method 100. For each cup dropper (or for each loading location of the plurality of indexed locations 48a-48d, the method 200 begins with a check at 202 that the cup holder 38 at the carousel position associated with the specific cup dropper is empty. It will be recognized that a sensor may be positioned in association with each of the loading locations 48a-48d and operable to check if a cup exists in the cup holder presently at the associated loading location. In an example, this sensor is an ultrasound sensor that checks for the existence of a cup in the cup holder 38. This serves as a basic check or confirmation that the cup holder 38 is capable of receiving a cup. If the cup holder is full, then then at 204, the cup dropper does not operate to dispense a cup this iteration.

Next, at 206, a check is made, for example by the controller, to determine if the carousel position currently at the loading location of the cup dropper has already been assigned a cup, or if the carousel position is currently unassigned. If the carousel position has been assigned, then at 204, the cup dropper does not operate to dispense a cup this iteration. However, if the carousel position has not yet been assigned with a cup, then the method 200 progressed to 208, where a determination is made if the cup dropper has one or more allocations of cups for beverage orders. Again, if the cup dropper does not have any allocations, then at 204 the cup dropper does not operate to dispense a cup this iteration. If, however, the cup dropper does have allocations, then at 210 the cup dropper operates to dispense a cup into the cup holder 38 of the carousel position current at the cup loading location of the respective cup dropper. As previously noted, this action exemplarily triggers the assignment of a specific beverage order to that carousel position for the automated beverage dispenser to complete fulfilment of that beverage order exemplarily with ice and a beverage. Lastly, at 214, the carousel advances each carousel position to the subsequent indexed location and the method 200 is repeated for this new iteration.

FIG. 6 is a flow chart depicting an example of a method 300 of loading a next customer order and allocating the beverage orders of the customer order to the cup droppers. Because the automated beverage dispenser 10 is configured to receive a queue of customer orders from the POS, it is desirable to efficiently assign the beverages of the customer order to the carousel positions, but to also keep customer orders together without intermixing of customer orders. Therefore, the method 300 provides a determination of when to load and allocate a next customer order taking into account all of the beverage orders of the current customer order. As used herein cup dropper 1 coincides with the loading location of the indexed location 48a furthest from the beverage dispensing system (e.g. indexed location 48f) along the path of rotation of the carousel. Cup dropper 2 refers to the cup dropper at the next loading location 48b. Cup dropper 3 and cup dropper 4 similarly correspond to loading locations 48c and 48d, respectfully. This can continue for N cup droppers as used in examples of the automated beverage dispenser, while the example of four cup droppers is specifically used herein. At steps 302-310, the current state of allocations at each of the cup droppers is checked. Recognizing that the cup holder at the next carousel position to be aligned at loading location 48a will be unassigned, the check determines if there are no cup droppers with more remaining allocations than could be fulfilled if every carousel position at the loading locations were currently empty. Therefore, at 302 it is asked if cup dropper 1 (48a) has less than 1 allocation, at 304 it is asked if cup dropper 2 (48b) has less than 2 allocations, at 306 it is asked if cup dropper 3 (48c) has less than 3 allocations, at 308 it is asked if cup dropper 4 has less than 4 allocations, and at 310 it is asked if cup dropper N has less than N allocations. If any of these answers are no, then the method does not load a next customer order and the method goes to 312 for the next carousel cycle increment. If each of these queries are answered in the affirmative, then this initial threshold has been met for the system to load a next customer order.

At 314, the currently loaded allocations are further analyzed to determine if the system can assign every cup remaining in the allocations to an open carousel position. First, at 314 because there are N total cup droppers (and thus loading locations) the cup dispenser cannot assign and drop more than N cups in a single carousel cycle increment. Therefore, there must be fewer than N total allocations currently in the system. Additionally, the number of unassigned carousel positions must be greater than or equal to the total number of allocations. If these conditions are not met, then the method does not load the next customer order and waits for the next carousel cycle at 312.

If the above conditions are met, then at 316 the controller loads the next customer order from the customer order queue from the POS. This customer order is divided into its constituent beverage orders and at 318 those beverage orders are allocated to the respective cup droppers based upon the sizes of the cups in the beverage orders and the cup size dispensed by each cup dropper.

After the beverage order is allocated to the dispensers at 318, the method returns to 302 to determine if another customer order can be loaded as well. In examples, customer orders may include only a single beverage order and therefore, it is possible that up to four (single cup) customer orders could potentially be loaded and allocated before the next carousel cycle increment. Eventually, the loading criteria are not met and the method returns to 312 for the next carousel cycle increment.

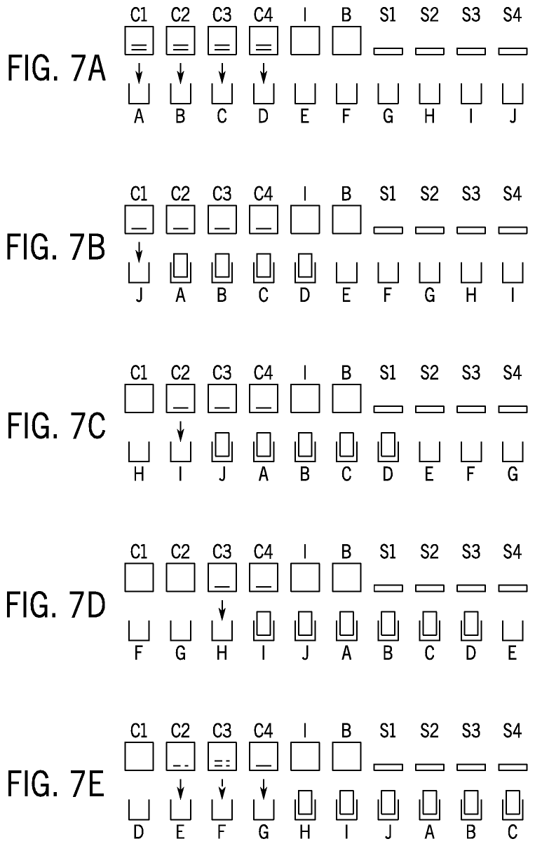

FIGS. 7A-7E diagrammatically depict the relative operations of the above methods in a further example. In the example, starting at FIG. 7A, each of cup dropper C1-C4 are allocated two cups to dispense for beverage orders in a customer order. Carousel positions A-D are respectively aligned with cup droppers C1-C4. Because none of the carousel positions A-D are filled with a cup yet, each cup dropper C1-C4 operates to drop a cup into the aligned cup position. Now that cups have been dropped into carousel positions A-D, the system can operate to assign the beverages associated with the dropped cups to those respective carousel positions A-D for ice and beverage dispense. Because there is no cup in carousel position J, the carousel then advances one increment.

At FIG. 7B, Carousel position J now rotates to be aligned with cup dropper C1. Because carousel position J is empty and cup dropper C1 has a cup allocation, C1 operates to dispense the cup into carousel position J. The cup in carousel position D is now below the Ice dispenser I and receives ice according to the beverage order. The beverage order for the cup dispensed into carousel position J is associated to carousel position J. Because there is no cup at carousel position I, the carousel then advances one increment.

At FIG. 7C, the carousel has subsequently advanced two total increments from that shown at Fig. B, such that the open carousel position I is at the loading location below cup dispenser C2. Because carousel position I is empty and cup dropper C2 has a cup allocation, C2 operates to dispense the cup into carousel position I. The beverage order for the cup dispensed into carousel position I is associated to carousel position I. The cup in carousel position B is below the ice maker I and receives ice according to the beverage order associated with carousel position B. The cup in carousel position C is below the beverage dispensing system and receives beverage according to the beverage order. S1 is the first staging location where a completed beverage is held to be taken by a crew member for delivery to the customer. The cup in carousel position D has a completed beverage order and is held in the first staging location S1. Because there is no cup at carousel position G, the carousel then advances one increment.

At FIG. 7D, the carousel has subsequently advanced two total increments from that shown in FIG. 7C, such that the open carousel position H is at the loading location below cup dispenser C3. Because carousel position H is empty and cup dropper C3 has a cup allocation, C3 operates to dispense the cup into carousel position H. The beverage order for the cup dispensed into carousel position H is associated to carousel position H. The cup in carousel position J is below the ice maker I and received ice according to the beverage order associated with carousel position J. The cup in carousel position A is below the beverage dispensing system and receives beverage according to the beverage order associated with carousel position A. The cups in carousel positions B, C, and D have been filled with beverage and are held is staging locations S1-S3. Because there is no cup at carousel position G, the carousel then advances one increment.

At FIG. 7E, the carousel has subsequently advanced two total increments from that shown in FIG. 7D, such that the open carousel position G is at the loading location below cup dispenser C4. However, this action required that the cup filled with beverage at carousel position D be removed from the staging location S4 by a crew member, before the system could advance the carousel position D to the first loading location below cup dropper C1. This advancement brought open carousel position G below cup dropper C4. Additionally, though through the method described above with respect to FIG. 6, because all of the previous order could be fulfilled without intermixing orders, the system was able to load the next customer order and allocate those beverage orders with one cup to cup dropper C2 and two cups to cup dropper C3. Open carousel positions E and F are respectively below cup droppers C2 and C3. Therefore, within this iteration, the cup dispenser operates to drop a cup from C4 to complete the first customer order, but then also drop cups from C2 and C3 to start the next customer order without any empty carousel positions.

FIG. 8 is a system diagram of the hardware that can be used to implement the functions of the automated beverage dispenser 10 described above. It will be recognized that during the course of operation of the automated beverage dispenser some or all of the methods 100, 200, 300 may be carried out by the components as described herein as well as by others as would be recognized based upon the present disclosure.

The automated beverage dispenser 10 includes the cup dispenser 24, carousel 26, ice dispenser 28, and the beverage dispenser 32 as previously described. These sub-systems of the automated beverage dispenser 10 are communicatively connected to a controller 50, which operates to carry out the functions and methods as described above. The controller is further communicatively connected to the POS 52 from which it receives the customer orders which each include one or more beverage orders. As noted above, the communicative connection between the controller 50 of the automated beverage dispenser and the POS 52 may be direct or indirect. Thus the controller 50 may receive the beverage orders directly from the POS 52 or through an intermediary system (not depicted). The controller is communicatively connected to one or more memory 54 on one or more non-transient computer readable media. The memory may not only store the computer executable code executable by the controller to carry out the functions described herein, but also to store the cup allocations to the cup droppers and the assignments of beverage orders to carousel positions as described above. The controller 50 is further communicatively connected to one or more cup sensors 56, exemplarily as described above which function to provide confirmation of when cup holders 38 of various carousel positions about the carousel 26 are empty or have a cup therein.

The memory 54 exemplarily stores computer executable code and data structures for managing beverage order fulfillment. In some aspects, the memory 54 includes a first data structure storing cup allocations, wherein each cup allocation associates a pending beverage order with a particular cup dropper. In some aspects, the memory 54 includes a second data structure storing carousel position assignments, wherein each assignment associates a beverage order with a particular carousel position containing a cup for that order. The controller 50 maintains these data structures separately, updating the cup allocations when beverage orders are allocated to cup droppers and when allocations are decremented after cup dispensing, and updating the carousel position assignments when beverage orders are assigned to carousel positions after cup dispensing.

In examples, the controller 50 includes one or more processors which may be any suitable hardware processor or combination of processors, such as a central processing unit (CPU), a graphics processing unit (GPUT), an accelerated processing unit (APUT) a microcontroller, an application specific integrated circuit (ASIC), a field-programmable gate array (FPGA), etc. In examples, communicatively connected may mean wired or wireless communication connections. These may include any suitable hardware, firmware, and/or software for communicating information over a communication network or directly between hardware components of the system.

Communicative connections can include one or more transceivers, one or more communication chips and/or chip sets, etc., that can be used to establish a wired and/or wireless communication link. Communicative connections may include hardware, firmware, and/or software that can be used to establish a direct or indirect wired connection and/or a direct or indirect wireless connection, such as a Bluetooth connection, Bluetooth Low Energy connection, a ZigBee connection, a Wi-Fi connection, a cellular connection (e.g., an uplink connection, a downlink connection, or a sidelink connection), an Ethernet connection, etc.

The cup sensors are exemplarily ultrasonic as previously described, but may be other sensor types as may be recognized, including, but not limited to CMOS, CCD or any other suitable image sensor or camera, etc. Other sensor examples may include a weight or load sensor.

Memory can include any suitable storage device or devices that can be used to store instructions, values, etc., that can be used, for example, by the processor to generate data, to receive data, to analyze data, to present content using the display, or to communicate between components. Memory can include any suitable volatile memory, non-volatile memory, storage, or any suitable combination thereof, including but not limited to random access memory (RAM), read-only memory (ROM), electronically-erasable programmable read-only memory (EEPROM), one or more flash drives, one or more hard disks, one or more solid state drives, one or more optical drives, etc. Memory can have encoded thereon a computer program that when executed by the controller, the controller carries out the processing of input and outputs as described above to carry out the described functionalities, including but not limited to carrying out the above functionality using one or more state machine implementations.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification. It is recognized that the examples provided herein as well as in the references incorporated by reference are examples of the disclosure and that still further combinations of the features of these individual disclosures are recognized to be made and are considered to be within the scope of the present disclosure.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An automated beverage dispenser comprising:
a cup dispenser, comprising at least a first cup dropper and a second cup dropper;
a carousel defining a plurality of carousel positions each with a cup holder, the carousel configured to move the carousel positions about carousel through a plurality of locations, the plurality of locations comprising a first loading location coincident to the first cup dropper and a second loading location coincident to the second cup dropper;
a beverage dispensing system configured to dispense a beverage, wherein the plurality of locations of the carousel comprises a beverage dispense location coincident to the beverage dispensing system; and
a controller configured to receive a first customer order comprising first plurality of beverage orders and allocate at least one beverage order of the first plurality of beverage orders to the first cup dropper and at least one beverage order of the first plurality of beverage orders to the second cup dropper prior to operation of the cup dispenser according to the first customer order.

2. The automated beverage dispenser of claim 1, wherein the first cup dropper and the second cup dropper are respectively configured to receive a stack of cups, singulate a cup from the stack, and to deliver the singulated cup to a cup holder of the carousel.

3. The automated beverage dispenser of claim 1, wherein the controller is configured to operate the first cup dropper to dispense a first cup into the cup holder at the first loading location and the controller is further configured to assign a beverage order of the at least one beverage order allocated to the first cup dropper to a first carousel position of the plurality of carousel positions that is currently at the first loading location, and decrement an allocation from at least one beverage orders allocated to the first cup dropper.

4. The automated beverage dispenser of claim 3, wherein the controller is configured to operate the second cup dropper to dispense a second cup into the cup holder at the second loading location and the controller is further configured to assign a beverage order of the at least one beverage order allocated to the second cup dropper to a second carousel position of the plurality of carousel positions that is currently at the second loading location.

5. The automated beverage dispenser of claim 3, wherein the carousel is configured to advance the first carousel position to the beverage dispense location of the plurality of locations of the carousel, and the controller is configured to operate the beverage dispense system to dispense the beverage according to the beverage order assigned to the first carousel position.

6. The automated beverage dispenser of claim 3, wherein the controller is configured to confirm that the first carousel position has not been assigned a beverage order before operating the first cup dropper to dispense the first cup into the cup holder of the first carousel position at the first loading location.

7. The automated beverage dispenser of claim 6, wherein the controller is configured to cause the carousel to advance so that the first carousel position is located at the second loading location and then evaluate if the first cup dropper has at least one beverage order allocation.

8. The automated beverage dispenser of claim 7, further comprising a first cup sensor positioned relative to the first loading location, wherein the controller confirms that no cup is presented in the cup holder at the first loading location before operation of the first cup dropper to dispense the first cup, and the controller confirms that a cup is present in the cup holder at the first loading location after operation of the first cup dropper to dispense the first cup.

9. The automated beverage dispenser of claim 1, wherein the controller is configured to assign the beverage order to a carousel position of the plurality of carousel positions after a cup of the beverage order has been dispensed to that carousel position, the beverage order comprising instructions for the beverage to be dispensed from the beverage dispensing system when that carousel position reaches the beverage dispense location.

10. The automated beverage dispenser of claim 1, wherein the controller is configured to evaluate the beverage orders allocated to at least the first cup dropper and the second cup dropper and then to evaluate unassigned carousel positions before loading a subsequent customer order comprising one or more subsequent beverage orders.

11. The automated beverage dispenser of claim 1, wherein the cup dispenser further comprises a third cup dropper and a fourth cup dropper, and the plurality of locations further comprises a third loading location coincident to the third cup dropper and a fourth loading location coincident to the fourth cup dropper and each of the first, second, third, and fourth cup droppers occupy separate fixed locations relative to the carousel, and two or more of the first, second, third, and fourth cup droppers are configured to operate simultaneously to dispense cups.

12. A method of automated beverage dispensing, the method comprising:
receiving a customer order comprising at least a first beverage order and a second beverage order;
allocating the first beverage order to a first cup dropper of a cup dispenser and allocating the second beverage order to a second cup dropper of the cup dispenser, wherein the first cup dropper is at a first fixed location that coincides with a first loading location of a plurality of carousel locations and the second cup dropper is at a second fixed location that coincides with a second loading location of the plurality of carousel locations;
operating at least one of the first cup dropper and the second cup dropper to dispense a cup into a cup holder of the carousel at the respective first loading location or second loading location;
decrementing the first beverage order and/or the second beverage order from the allocation to the at least one of the operated first cup dropper and second cup dropper; and
assigning the first beverage order and/or the second beverage order to a carousel position of a plurality of carousel positions to which the respective first cup dropper and/or second cup dropper dispensed a cup.

13. The method of claim 12, further comprising advancing the carousel position to a beverage dispense location and operating a beverage dispense system that coincides with the beverage dispense location to dispense the beverage according to the first beverage order or the second beverage order assigned to the carousel position.

14. The method of claim 12, further comprising evaluating the plurality of carousel positions, each carousel position of the plurality of carousel positions having a cup holder, to determine if the carousel position has already been assigned a beverage order.

15. The method of claim 12, wherein at each of the first cup dropper and the second cup dropper the method comprises:
determining if the cup holder at the currently coinciding carousel position is empty by evaluating a sensor signal;
evaluating if a beverage order has been assigned to the currently coinciding carousel position;
evaluating if the cup dropper has at least one beverage order allocation; and
subsequently dispensing a cup the cup holder at the currently coinciding carousel position is empty, no beverage order is currently assigned to the currently coinciding carousel position, and the cup dropper has at least one beverage order allocation.

16. The method of claim 12, further comprising:
receiving a plurality of customer orders, each customer order comprising at least one beverage order;
allocating the at least one beverage order of a next customer order of the plurality of customer orders if both a total number of beverage orders allocated to the first and second cup droppers is less than a total number of cup droppers and a total number of allocated beverage orders is less than a total number of currently unassigned conveyor positions; and
advancing the carousel to a next position increment if either of the total number of beverage orders allocated to the first and second cup droppers is greater than or equal a total number of cup droppers or a total number of allocated beverage orders is greater than or equal to a total number of currently unassigned conveyor positions.

17. The method of claim 12, further comprising a third cup dropper at a third fixed location that coincides with a third loading location of a plurality of carousel locations, the method comprising:
allocating a third beverage order to the third cup dropper;
confirming that no beverage orders have been assigned to first, second, or third carousel positions, each associated with respective cup holder of the carousel at the respective first, second, and third loading locations;
operating the first, second, and third cup droppers to simultaneously dispense cups into the cup holders of the first, second and third carousel positions;
assigning the first beverage order to the first carousel position, assigning the second beverage order to the second carousel position, and assigning the third beverage order to the third carousel position; and
advancing the first carousel position to a beverage dispense location and operating a beverage dispense system that coincides with the beverage dispense location to dispense the beverage according to the first beverage order.

18. A method of automated beverage dispensing from an automated beverage dispenser comprising a first cup dropper, a second cup dropper, and a carousel defining a plurality of carousel positions each with a cup holder, the carousel configured to move the carousel positions about carousel through a plurality of locations, the plurality of locations comprising a first loading location coincident to the first cup dropper and a second loading location coincident to the second cup dropper, the method comprising:
receiving a customer order comprising at least a first beverage order and a second beverage order;
allocating the first beverage order to the first cup dropper and allocating the second beverage order to the second cup dropper;
evaluating the plurality of carousel positions to determine if a first carousel position at the first loading location or a second carousel position at the second loading location are assigned with a beverage order;
operating the first cup dropper and/or the second cup dropper to dispense a cup into a cup holder at the first carousel position and or the second carousel position not assigned with a beverage order;
for either of the first cup dropper or the second cup dropper, if a cup was dispensed, decrementing the allocation of the respective first beverage order and/or the second beverage order and assigning the first beverage order and/or the second beverage order to the respective first carousel position and/or the second carousel position;
advancing the carousel to position the first carousel position or the second carousel position at a beverage dispense location of the plurality of locations; and
operating a beverage dispense system that coincides with the beverage dispense location to dispense the beverage according the beverage order assigned to the first carousel position or the second carousel position.

19. The method of claim 18, wherein at each of the first cup dropper and the second cup dropper the method comprises:
determining if the cup holder at the currently coinciding carousel position is empty by evaluating a sensor signal;
evaluating if a beverage order has been assigned to the currently coinciding carousel position;
evaluating if the cup dropper has at least one beverage order allocation; and
subsequently dispensing a cup the cup holder at the currently coinciding carousel position is empty, no beverage order is currently assigned to the currently coinciding carousel position, and the cup dropper has at least one beverage order allocation.

20. The method of claim 18, further comprising:
receiving a plurality of customer orders, each customer order comprising at least one beverage order;
allocating the at least one beverage order of a next customer order of the plurality of customer orders if both a total number of beverage orders allocated to the first and second cup droppers is less than a total number of cup droppers and a total number of allocated beverage orders is less than a total number of currently unassigned conveyor positions; and
advancing the carousel to a next position increment if either of the total number of beverage orders allocated to the first and second cup droppers is greater than or equal a total number of cup droppers or a total number of allocated beverage orders is greater than or equal to a total number of currently unassigned conveyor positions.
